(19) United States
(12) Patent Application Publication
(10) Pub. No.: US 2025/0172187 A1
(43) Pub. Date: May 29, 2025

(54) VIBRATION DAMPER FOR A MOTOR VEHICLE

(71) Applicants: thyssenkrupp Bilstein GmbH, Ennepetal (DE); thyssenkrupp AG, Essen (DE)

(72) Inventor: Juergen SCHNEIDER, Iserlohn (DE)

(73) Assignees: thyssenkrupp Bilstein GmbH, Ennepetal (DE); thyssenkrupp AG, Essen (DE)

(21) Appl. No.: 18/955,522

(22) Filed: Nov. 21, 2024

(30) Foreign Application Priority Data
Nov. 24, 2023 (DE) 10 2023 132 902.2

(51) Int. Cl. F16F 9/348

(52) U.S. Cl. CPC F16F 9/3488; F16F 9/3481; F16F 2222/12; F16F 2230/007

(57) ABSTRACT

A vibration damper for a motor vehicle comprises a damper tube and a working piston, which is arranged in such a way as to be axially movable within the damper tube and divides the interior of the damper tube into a working space on the piston-rod side and a working space on the side remote from the piston rod, wherein the working piston has a main piston and at least one auxiliary piston, wherein the auxiliary piston has an auxiliary valve device, which is connected fluidically to a working space of the damper tube via a flow channel, wherein the auxiliary valve device comprises: an auxiliary valve body and an auxiliary valve piston, which is movable axially relative to the latter, and an auxiliary valve disc stack, which interacts with the auxiliary valve piston, wherein the auxiliary valve device has a preloading system for subjecting the auxiliary valve disc stack to a preloading force, and wherein the preloading system comprises a first pressure chamber and a second pressure chamber, which each have a variable volume.

### CROSS REFERENCE TO RELATED APPLICATION

This application is a U.S. Non-Provisional that claims priority to German Patent Application No. DE 10 2023 132 902.2, filed Nov. 24, 2023, the entire content of which is incorporated herein by reference.

### FIELD

The present disclosure relates to a vibration damper for a motor vehicle having a frequency-sensitive damping system.

### BACKGROUND

Vibration dampers having a frequency-sensitive damping system are known from DE 10 2016 208 845 A1, for example. Known vibration dampers having a frequency-sensitive damping system are provided on one side, for the tension stage or the compression stage, for example. Known vibration dampers having a frequency-sensitive damping system generally exhibit sluggish damping force adjustment in low speed ranges or damping force ranges of the vibration damper. It is therefore desirable to provide frequency-dependent damping of the vibration damper even at low excitation speeds. In particular, the aim is to achieve high damping at low frequencies, e.g. during cornering or braking, and less damping at high frequencies, e.g. travelling over cobbles.

Thus a need exists to provide a vibration damper having a frequency-sensitive damping system which allows frequency-sensitive damping force adjustment even in a low speed or damping force range.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a vibration damper in a longitudinal section according to one exemplary embodiment.

FIG. 2 shows a schematic illustration of a detail of a vibration damper in a longitudinal section according to another exemplary embodiment.

FIG. 3 shows a schematic illustration of a detail of a vibration damper in a longitudinal section according to another exemplary embodiment.

FIG. 4 shows a schematic illustration of a detail of a vibration damper without a main piston valve in a longitudinal section according to another exemplary embodiment.

FIG. 5 shows a schematic illustration of a detail of a vibration damper with a main piston valve and just precisely one auxiliary piston in a longitudinal section according to another exemplary embodiment.

### DETAILED DESCRIPTION

According to a first aspect, a vibration damper for a motor vehicle comprises: a damper tube and a working piston, which is arranged in such a way as to be axially movable within the damper tube and divides the interior of the damper tube into a working space on the piston-rod side and a working space on the side remote from the piston rod, wherein the working piston has a main piston and at least one auxiliary piston. The auxiliary piston has an auxiliary valve device, which is connected fluidically at least to a working space of the damper tube via a flow channel, wherein the auxiliary valve device has an auxiliary valve body and an auxiliary valve piston, which is movable axially relative to the latter. The auxiliary valve device also has an auxiliary valve disc stack, which interacts with the auxiliary valve piston. In particular, the auxiliary valve disc stack rests directly or indirectly against the auxiliary valve piston. The auxiliary valve device has a preloading system for subjecting the auxiliary valve disc stack to a preloading force, wherein the preloading system comprises a first pressure chamber and a second pressure chamber, which each have a variable volume.

The volume of the first and/or of the second pressure chamber is preferably capable of being enlarged or reduced, in particular as a function of the hydraulic pressure prevailing in the respective pressure chamber. The first and/or the second pressure chamber are/is preferably arranged in such a way that they/it subject/subjects the auxiliary valve piston to an axial force, in particular when the respective pressure chamber is subjected to hydraulic pressure. In particular, the first pressure chamber and/or the second pressure chamber are/is arranged and designed in such a way that a change in the volume thereof results in a movement of the auxiliary valve piston in the axial direction. The auxiliary valve piston preferably rests directly or indirectly at least against one pressure chamber, with the result that preferably at least one side face of the auxiliary valve piston delimits the pressure chamber. In particular, the second pressure chamber preferably rests directly against the auxiliary valve piston. The pressure chambers are preferably arranged separately from one another. The auxiliary valve disc stack can preferably be subjected to a preloading force via the auxiliary valve piston, with the result that the auxiliary valve disc stack is preloaded against the corresponding auxiliary valve seat.

A preloading system with two or more pressure chambers, each having a variable volume, has the technical effect that the respective volumes of the pressure chambers change at different rates when excited by different frequencies and thus bring about frequency-sensitive preloading of the auxiliary valve disc stack.

The vibration damper is a single-tube or multi-tube vibration damper, for example. For example, a multi-tube vibration damper for a vehicle comprises an outer tube and an inner tube arranged coaxially therewith, wherein a compensating space for receiving hydraulic fluid is formed between the outer tube and the inner tube, and comprises a working piston, which is connected to a piston rod and is arranged in such a way as to be movable backwards and forwards within the inner tube, wherein the interior of the inner tube is divided by the working piston into a first working space on the piston-rod side and a second working space on the side remote from the piston rod. The compensating space is preferably filled at least partially, in particular at the upper end, with a gas. The outer tube preferably at least partially forms the housing of the vibration damper. The inner surface of the inner tube is preferably designed as a guide for the working piston. The working piston preferably has a valve device, by which the first and the second working space are connected to one another. In the case of a single-tube vibration damper, there is preferably no outer tube provided. The inner tube is referred to as a damper tube and, as described above with reference to the inner tube, accommodates the piston rod and the working piston.

In the case of a multi-tube vibration damper or single-tube vibration damper, the vibration damper has, in particular, a closure assembly which is designed and arranged to seal off the interior of the outer tube fluidically on the piston-rod side. The piston-rod end of the inner tube is preferably secured on the closure assembly. On the opposite side from the closure assembly, at the end remote from the piston rod, the compensating space and the second working space are preferably connected fluidically by means of a bottom valve. The compensating space is preferably connected fluidically to the first or second working space via openings in the inner tube. For example, the compensating space is connected to the inner tube via the bottom valve.

In the case of a single-tube vibration damper, the vibration damper has, in particular, a closure assembly which is designed and arranged to seal off the interior of the damper tube fluidically on the piston-rod side. The piston-rod end of the damper tube is preferably secured on the closure assembly. On the opposite side from the closure assembly, at the end remote from the piston rod, the interior of the damper tube is preferably sealed off fluidically by means of an axially movable sealing element. The sealing element preferably separates a gas space adjoining it in the axial direction from the working space filled with hydraulic fluid.

In the following description, the term “vibration damper” should be understood to mean both a multi-tube vibration damper and a single-tube vibration damper, wherein the damper tube is the inner tube of a multi-tube vibration damper.

The working piston preferably comprises a main piston, which at least in part rests fluid-tightly against the damper tube, and at least one or two auxiliary pistons. The auxiliary pistons are arranged spaced apart from the damper tube, for example, thus allowing fluid to flow between the auxiliary pistons and the inner wall of the damper tube. The auxiliary pistons are preferably mounted coaxially with respect to the main piston on the piston rod, preferably in a fixed position. For example, one of the auxiliary pistons, the first auxiliary piston, is arranged within the working space on the piston-rod side and in the direction of tension relative to the main piston. By way of example, the other auxiliary piston, the second auxiliary piston, is arranged within the working space on the side remote from the piston rod and in the direction of compression relative to the main piston. The main piston is preferably arranged between the two auxiliary pistons. The main piston and the at least one or the two auxiliary pistons each preferably have a respective valve device.

A flow channel, which connects the auxiliary valve devices of the respective auxiliary pistons fluidically to one another, is formed in the piston rod, for example. The working space on the side remote from the piston rod and that on the piston-rod side are preferably connected fluidically to one another via the flow channel and the auxiliary valve devices. In particular, the flow channel is designed substantially as an annular space and extends through the piston rod in the axial direction. The flow channel preferably has a plurality of flow passages for carrying the hydraulic fluid into the respective auxiliary piston, in particular the respective auxiliary valve device. For example, the flow channel has a flow passage into each auxiliary piston, in particular each auxiliary valve device.

In particular, the flow channel extends between the working space on the side remote from the piston rod and that on the piston-rod side to the at least one auxiliary piston. If the vibration damper has two auxiliary pistons, the flow channel preferably extends from the first auxiliary piston, in particular from the first auxiliary valve device, to the second auxiliary piston, in particular the second auxiliary valve device. The flow channel is preferably arranged hydraulically in parallel with the main piston, in particular the main valve device.

Each auxiliary valve device preferably has a fluid inlet for allowing hydraulic fluid to enter the respective auxiliary piston, in particular the respective auxiliary valve device, wherein each fluid inlet is optionally assigned a non-return valve, thus ensuring that flow through the fluid inlet is allowed only in one flow direction. The non-return valve is preferably arranged in such a way that it completely closes the fluid inlet and it preferably comprises at least one spring disc, which preferably completely covers the respective fluid inlet. Flow through each fluid inlet is preferably allowed only in the flow direction from the respective working space inwards into the respective auxiliary valve device. For example, the non-return valve of the fluid inlet is formed by the auxiliary valve disc stack.

Each auxiliary valve device preferably has a fluid outlet for allowing hydraulic fluid out of the respective auxiliary valve device. Each fluid outlet is preferably assigned at least one outlet spring disc designed as a non-return valve, and therefore flow through the fluid outlet is allowed only in one flow direction.

The auxiliary valve device preferably has an auxiliary valve body, which is preferably mounted in a fixed position on the piston rod. In particular, an axially movable auxiliary valve piston is arranged within the auxiliary valve body. The auxiliary valve piston preferably rests at least partially against the auxiliary valve body and is mounted in such a way as to be movable in the axial direction relative to the latter and to the piston rod. A sealing element is preferably mounted between the auxiliary valve piston and the auxiliary valve body to seal them off fluidically with respect to one another. The auxiliary valve body is preferably of cup-shaped design and open in the axial direction of the outlet spring disc stack. The auxiliary valve piston is preferably accommodated within the cup-shaped auxiliary valve body in such a way that it slides on the piston rod and the auxiliary valve body in the axial direction. The auxiliary valve body preferably forms the housing of the auxiliary valve device, in particular of the auxiliary piston. In particular, the auxiliary valve body is in the form of a hollow cylinder with a top region facing in the direction of the main piston, a side region in the form of a hollow cylinder and a bottom region facing away from the main piston. The auxiliary valve piston preferably comprises the auxiliary valve seat and rests by means of the latter against the auxiliary valve disc stack.

The auxiliary valve device comprises the preloading system for subjecting the auxiliary valve piston to an axial force. The preloading system is preferably part of the respective auxiliary piston and of the respective auxiliary valve device. The first pressure chamber and a second pressure chamber are connected hydraulically in series with one another, for example. The pressure chambers are preferably arranged in such a way that they interact with the auxiliary valve piston, with the result that the auxiliary valve piston is moved axially when there is a change in the pressure in the pressure chambers. The pressure chambers are preferably situated on the opposite side of the auxiliary valve piston from the auxiliary valve disc stack. In particular, the hydraulic effective area of the auxiliary piston on the side facing the pressure chambers is larger than on the side facing the auxiliary valve disc stack. If the same pressure is applied to the auxiliary valve piston on both sides, in particular on the pressure chamber and the fluid inlet into the auxiliary valve device, the auxiliary valve piston is preferably deflected in the direction of the auxiliary valve disc stack, in particular in the preloading direction.

The auxiliary valve disc stack is preferably mounted in such a way as to be axially movable relative to the auxiliary valve body and/or the piston rod, with the result that it preferably moves axially together with the auxiliary valve piston. It is likewise conceivable for the auxiliary valve disc stack to be mounted in a fixed manner on the auxiliary valve body and/or the piston rod. The auxiliary valve piston is of single-part or multi-part design, for example. In particular, the auxiliary valve disc stack rests directly or indirectly against the auxiliary valve piston. For example, the auxiliary valve disc stack rests against an auxiliary valve seat, which is formed on the auxiliary valve piston or the auxiliary valve housing, for example.

The vibration damper comprises, for example, an external damping valve device for damping the piston rod movement in the tension stage and/or in the compression stage. The damping valve device is preferably mounted outside the working piston, the inner tube and the outer tube.

According to a first embodiment, the first and second pressure chambers are connected hydraulically in series with one another. In a loaded case, the second pressure chamber is preferably arranged downstream of the first pressure chamber and, in particular, rests directly against the auxiliary valve piston. In particular, the pressure chambers have different volumes. The first pressure chamber preferably has a smaller volume than the second pressure chamber. Connecting the pressure chambers in series, especially with different volumes, ensures a graduated speed profile for the movement of the auxiliary piston, wherein, owing to the series connection, the second pressure chamber brings about a displacement of the auxiliary piston only when the first pressure chamber has been filled.

The first pressure chamber is arranged in such a way, for example, that the auxiliary valve piston can be moved over a first axial travel range by means of the force resulting from the hydraulic pressure of the first pressure chamber, and wherein the second pressure chamber is arranged in such a way that the auxiliary valve piston can be moved over a second axial travel range by means of the force resulting from the hydraulic pressure of the second pressure chamber. The first axial travel range is part, in particular a segment, of the second axial travel range. The second axial travel range is preferably the maximum axial deflection, in particular the full axial range of movement of the auxiliary piston. The different volumes in the different pressure chambers advantageously bring about different axial movements of the auxiliary piston, and therefore the axial deflection of the piston for low and high speed ranges of the movement of the working piston is different.

According to another embodiment, the preloading system has a first orifice for allowing hydraulic fluid into the first pressure chamber and a second orifice for allowing hydraulic fluid into the second pressure chamber. The second orifice is preferably arranged between the first and the second pressure chamber. The first and the second pressure chamber are connected directly to one another via the second orifice, for example. The first and the second orifice are preferably each designed as an inlet, in particular as an inlet opening, for allowing hydraulic fluid into the respective pressure chamber. The fluid inlet for allowing hydraulic fluid into the preloading system is preferably covered by a spring disc, which forms a non-return valve. In particular, the first orifice is designed as an opening in the spring disc. The filling of the pressure chambers via respectively assigned orifices offers the advantage of separate filling, e.g. at different filling rates, of the respective pressure chambers. The first orifice is optionally designed as a flow opening in the flow channel, wherein, in particular, only one auxiliary piston is provided.

According to another embodiment, the first orifice has a larger cross-sectional area than the second orifice. For example, the cross-sectional area of the first orifice is about 2 to 10, preferably 3 to 6, in particular 5, times the cross-sectional area of the second orifice. As an option, the two orifices are the same size. For example, the first orifice is designed as a main flow channel in the main piston or as a cross-sectional constriction in the main flow channel of the main piston. For example, the main piston has no main valve device. The orifices have different cross-sectional areas, for example. This ensures different filling rates of the two pressure chambers. A larger first orifice ensures more rapid filling of the first pressure chamber, resulting in a more rapid change in the volume of the first pressure chamber, and thus also the auxiliary piston is moved at a higher speed during the filling of the first pressure chamber than during the filling of the second pressure chamber.

According to another embodiment, the preloading system has a separating disc, which fluidically separates the first pressure chamber and the second pressure chamber from one another. The separating disc is a separating spring disc, for example.

According to another embodiment, the second orifice is designed as an opening in the separating disc, in particular the separating spring disc, for fluidically connecting the first and the second pressure chamber. The first and the second pressure chamber are preferably connected fluidically to one another exclusively via the second orifice. This enables series connection of the two pressure chambers and preferentially filling of the pressure chambers at different rates.

The second pressure chamber is preferably formed between the auxiliary valve piston and the separating disc, wherein the first pressure chamber is formed between the separating disc and the auxiliary valve body or the main piston. The separating disc and the auxiliary valve disc stack are preferably arranged on mutually opposite sides of the auxiliary valve piston.

For example, the first and/or second orifice designed as an opening are/is of circular or slotted design. In particular, the separating disc has a plurality of openings, which are preferably arranged at the same radial distance from the piston rod and together form the second orifice.

According to another embodiment, the separating disc is mounted in such a way as to be axially movable relative to the auxiliary valve body and the piston rod. According to another embodiment, the separating disc rests against the auxiliary valve piston and can preferably be moved with the latter. The axial mobility of the separating disc enables a change in the volume of the first pressure chamber during a movement of the separating disc, in particular together with the auxiliary valve piston, and thus enables simple coupling of the change in the volume of the first pressure chamber with a movement of the auxiliary piston.

According to another embodiment, the preloading system has an axial stop for limiting the axial movement of the separating disc. The stop is preferably formed in the auxiliary valve body and, in particular, forms a contact surface for the separating disc. In particular, the contact surface is at a distance from the bottom region. The side region of the auxiliary valve body preferably has an inner wall, which is designed as an axial sliding surface of the auxiliary valve piston and along which the auxiliary valve piston can be made to slide. A recess is preferably formed in the inner wall, the said recess extending axially from the end facing in the direction of the bottom region in the direction of the auxiliary valve piston and opening into the contact surface. The stop, in particular the contact surface, preferably extends in the radial direction and preferably forms an axial stop for the spring disc. The stop is preferably designed and arranged in such a way that it limits the axial movement of the separating disc and thus the enlargement in the volume of the first pressure chamber.

According to another embodiment, the flow channel has a flow passage, which opens into the first auxiliary piston to allow the entry of hydraulic fluid, and wherein the flow channel has a further flow passage, which opens into the second auxiliary piston to allow the entry of hydraulic fluid. For example, the flow channel has precisely two or more flow passages for fluidically connecting the flow channel to the auxiliary pistons.

According to another embodiment, the auxiliary valve disc stack is secured on the valve body. For example, the auxiliary valve disc stack is mounted in a fixed position relative to the piston rod and cannot be moved relative to the latter. It is likewise conceivable for the auxiliary valve disc stack to be secured on the auxiliary valve piston.

According to another embodiment, the auxiliary valve piston has a recess, which at least partially forms the second pressure chamber. The recess preferably increases the hydraulic effective area of that side face of the auxiliary valve piston which faces the second pressure chamber.

According to another embodiment, the main piston has a main valve device, wherein the flow channel is arranged hydraulically in parallel with the main valve device. The main valve device preferably connects the working space on the piston-rod side to the working space on the side remote from the piston rod. The main valve device preferably comprises a main valve body and at least two main flow channels formed in the main valve body, a first main flow channel and a second main flow channel. The main flow channels preferably each extend from one end of the working piston, in particular of the main valve body, to the opposite end and are arranged separately from one another, preferably in a manner separated fluidically from one another.

The main valve device preferably comprises at least two spring disc valves, which are each mounted on the ends of the main valve device, in particular of the valve body. In particular, the spring disc valves are arranged in such a way that they each determine the flow passing through just one main flow channel. Each main flow channel is preferably assigned precisely one spring disc valve. The main valve device preferably has a first spring disc valve, which interacts with the first main flow channel in such a way that, preferably as a function of the flow velocity, it determines the flow of hydraulic fluid passing through the main flow channel.

Each spring disc valve preferably comprises at least one spring disc stack. The spring disc stacks are preferably each preloaded against a main valve seat formed in the main valve body and rest against it. The spring disc stacks are preferably arranged on the respective main valve seat in such a way that they rise from the main valve seat and completely or partially expose the flow cross section of the main flow channel only when there is a flow through the respective main flow channel in one direction.

By way of example, a sealing element, in particular a sealing ring, is mounted around the main valve seat in the circumferential direction, the said sealing element preferably resting fluid-tightly against the inner wall of the damper tube.

According to another embodiment, the working piston has two auxiliary pistons, each having an auxiliary valve device, wherein the auxiliary valve devices are connected fluidically to one another via the flow channel. This brings about frequency-sensitive damping as described above, both in the compression stage and in the tension stage.

According to another embodiment, each auxiliary valve device has a fluid inlet for allowing hydraulic fluid to enter the auxiliary valve device, wherein each auxiliary piston has a fluid outlet for allowing hydraulic fluid out of the auxiliary piston, and wherein the fluid inlet of the first auxiliary valve device is connected fluidically to the fluid outlet of the second auxiliary piston via the flow channel. Each fluid outlet interacts with an outlet spring disc stack, for example. The outlet spring disc stack is preferably arranged in such a way that it completely closes the fluid outlet and it preferably comprises at least one spring disc, which preferably completely covers the respective fluid outlet. As a preferred option, there can preferably be a flow through each fluid outlet only in the flow direction from the interior of the respective auxiliary valve device outwards into the respective working space, wherein the outlet spring disc stack is preferably designed as a non-return valve.

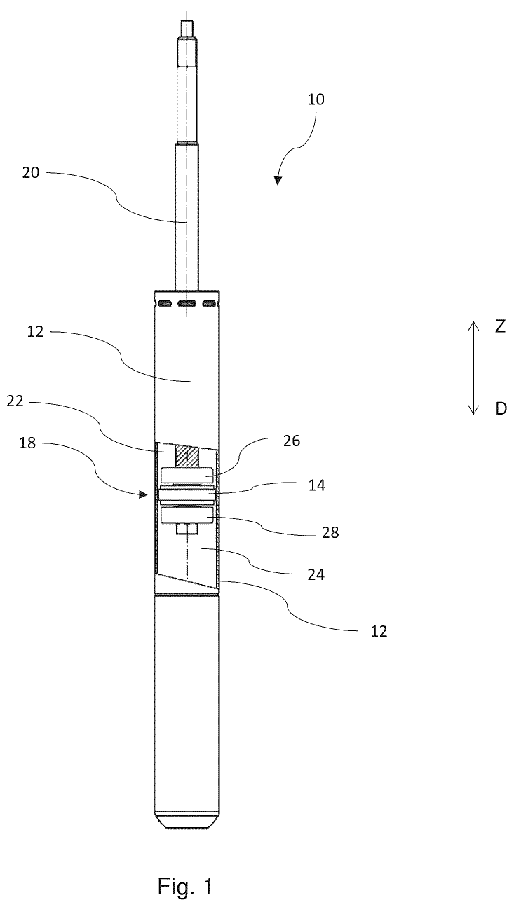

FIG. 1 shows a vibration damper 10, wherein the vibration damper 10 is a single-tube vibration damper. It is likewise conceivable for the vibration damper to be a multi-tube vibration damper, e.g. a 2-tube vibration damper. The vibration damper 10 has a damper tube 12, which, in the single-tube vibration damper illustrated in FIG. 1, forms the outer tube and forms an outer surface, in particular a housing, of the vibration damper 10.

A working piston 18 connected to a piston rod 20 is arranged within the damper tube 12 in such a way that it can be moved within the damper tube 12, wherein the damper tube 12 is preferably designed as a guide for the working piston 18. The working piston 18 has a valve device (not illustrated in FIG. 1), for example. The working piston 18 divides the interior of the damper tube 12 into a first working space 22, which is arranged on the piston-rod side, and a second working space 24, which is arranged on the side remote from the piston rod.

The interior of the damper tube 12 is sealed off fluidically on the piston-rod side by means of a closure assembly, for example. On the opposite side from the closure assembly, at the end remote from the piston rod, the interior of the damper tube 12 is sealed off fluidically with respect to an adjoining gas space by means of a separating piston, for example. The gas space is arranged within the damper tube 12, and the separating piston is preferably mounted in an axially movable manner within the damper tube 12.

It is likewise conceivable for the vibration damper to be designed as a multi-tube vibration damper. In the case of a vibration damper designed as a multi-tube vibration damper, an outer tube is arranged around the damper tube 12 and coaxially with respect to the latter. A compensating space is formed between the outer tube and the inner tube, the said space preferably being at least partially filled with a hydraulic fluid. The compensating space is partially filled with a gas, for example. On the opposite side from the closure assembly, at the end remote from the piston rod, the interior of the damper tube 12 of the multi-tube vibration damper is preferably sealed off fluidically by means of a bottom piece. By way of example, a bottom valve is arranged on the bottom piece, this bottom valve being mounted, in particular, on the end of the inner tube remote from the piston rod. The second working space 24 is preferably connected fluidically to the compensating space via the bottom valve.

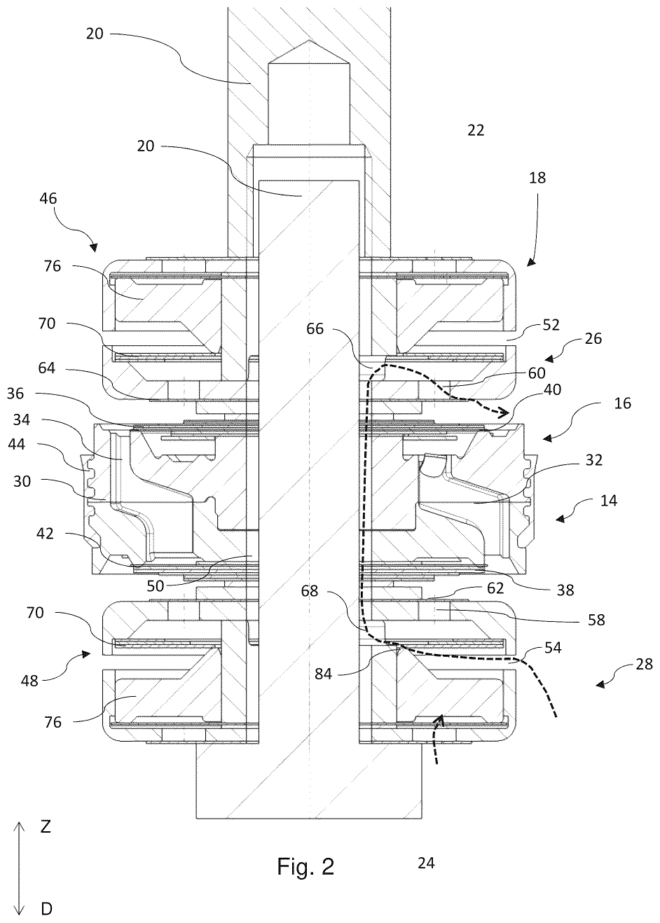

The working piston 18 comprises a main piston 14, which at least in part rests fluid-tightly against the damper tube 12. In addition, the working piston 18 comprises two auxiliary pistons 26, 28, a first auxiliary piston 26 and a second auxiliary piston 28. It is likewise conceivable for the working piston to have just one auxiliary piston. Purely by way of example, a vibration damper with two auxiliary pistons is illustrated in FIGS. 1 and 2. By way of example, the auxiliary pistons 26, 28 are arranged spaced apart from the damper tube 12, thus allowing fluid to flow between the auxiliary pistons 26, 28 and the inner wall of the damper tube 12. In particular, the auxiliary pistons 26, 28 are mounted coaxially with respect to the main piston 14 on the piston rod 20, preferably in a fixed position. By way of example, the first auxiliary piston 26 is arranged within the working space 22 on the piston-rod side and in the direction of tension Z relative to the main piston 26. By way of example, the second auxiliary piston 28 is arranged within the working space 24 on the side remote from the piston rod and in the direction of compression D relative to the main piston 26. The main piston 14 and the auxiliary pistons 26, 28 each preferably have a respective valve device. By way of example, the main piston 14 has a main valve device 16, and the auxiliary pistons 26, 28 each have an auxiliary valve device 46, 48.

FIG. 2 shows a detail view of the working piston 18 with the main piston 14 and the auxiliary pistons 26, 28. The main piston 14 has a main valve device 16. The main valve device 16 connects the working space 22 on the piston-rod side to the working space 24 on the side remote from the piston rod. The main valve device 16 comprises a main valve body 30 and at least two main flow channels 32, 34 formed in the main valve body 30, a first main flow channel 32 and a second main flow channel 34. The main flow channels 32, 34 preferably each extend from one end of the working piston 18, in particular of the main valve body 30, to the opposite end and are arranged separately from one another, preferably in a manner separated fluidically from one another.

The main valve device 16 comprises at least two spring disc valves 36, 38, which are each mounted on the ends of the main valve device 16, in particular of the valve body 30. The spring disc valves 36, 38 are arranged in such a way that they each determine the flow passing through just one main flow channel 32, 34. Each main flow channel 32, 34 is preferably assigned precisely one spring disc valve 36, 38. The main valve device 16 preferably has a first spring disc valve 36, which interacts with the first main flow channel 32 in such a way that, preferably as a function of the flow velocity, it determines the flow of hydraulic fluid passing through the main flow channel 32.

Each spring disc valve 36, 38 preferably comprises at least one spring disc stack. The spring disc stacks each comprise a plurality of spring discs and are each preloaded towards a main valve seat 40, 42 formed in the main valve body 30 and rest against this valve seat. The spring disc stacks are preferably arranged on the respective main valve seat 40, 42 in such a way that they rise from the main valve seat 40, 42 and completely or partially expose the flow cross section of the main flow channel 32, 34 only when there is a flow through the respective main flow channel 32, 34 in one direction. The spring disc valves 36, 38 are preferably designed as non-return valves, and therefore the spring disc stack does not rise from the respective main valve seat 40, 42 when there is a flow in the respective other direction. The respective spring disc valve 36, 38 is in an open position when the spring disc stacks of the respective spring disc valve 36, 38 have risen from the respective main valve seat 40, 42. When the spring disc stacks rest on the respective main valve seat 40, 42, the respective spring disc valve 36, 38 is in a closed position.

When the piston rod 20 is moved in a direction of compression D, the flow through the first main flow channel 32 is in the direction of tension Z, with the first spring disc valve 36 being opened during such through flow. The first spring disc valve 36 is therefore also referred to as a compression-stage valve. When the piston rod 20 is moved in a direction of tension Z, the flow through the second main flow channel 34 is in the direction of compression D, with the second spring disc valve 38 being opened during such through flow. The second spring disc valve 38 is therefore also referred to as a tension-stage valve. Here, the spring stiffness of the spring discs, the number and the dimensions of the spring discs preferably determine the damping characteristic of the piston movement in the direction of tension or compression.

By way of example, a sealing element 44 is mounted around the main valve seat 30 in the circumferential direction, the said sealing element preferably resting fluid-tightly against the inner wall of the damper tube 12.

The auxiliary pistons 26, 28 each have a respective auxiliary valve device 46, 48, which are preferably of substantially identical design. The auxiliary valve devices 46, 48 are preferably each arranged within the respective auxiliary piston 26, 28. By way of example, the piston rod 20 is of two-part design, although a single-part design is likewise conceivable. A flow channel 50, which connects the auxiliary pistons 26, 28, in particular auxiliary valve devices 46, 48, fluidically to one another, is preferably formed in the piston rod 20. The working space 22, 24 on the side remote from the piston rod and that on the piston-rod side are preferably connected to one another via the flow channel 50 and the auxiliary pistons 26, 28, in particular the auxiliary valve devices 46, 48. The flow channel 50 is preferably designed as an annular space and extends through the piston rod 20 in the axial direction. The flow channel 50 is formed within the piston rod 20 or between the piston rod 20 and the working piston 18 mounted thereon, for example. The flow channel 50 preferably has a plurality of flow passages 66, 68 for carrying the hydraulic fluid into the respective auxiliary piston 26, 28.

The flow channel 50 preferably extends in the flow direction of the hydraulic fluid from the first auxiliary piston 26, in particular from the first auxiliary valve device 46, to the second auxiliary piston 28, in particular the second auxiliary valve device 48. The flow channel 50 is preferably arranged hydraulically in parallel with the main piston 14, in particular the main valve device 16.

Each auxiliary valve device 46, 48 has a fluid inlet 52, 54 for allowing hydraulic fluid into the respective auxiliary valve device 46, 48. Each auxiliary piston 26, 28 has a fluid outlet 58, 60 for allowing hydraulic fluid out of the respective auxiliary piston 26, 28, in particular the respective auxiliary valve device 46, 48. Each fluid outlet 58, 60 is preferably assigned an outlet spring disc 62, 64, and therefore flow through the fluid outlet 58, 60 is allowed only in one flow direction. The outlet spring disc 62, 64 preferably comprises at least one spring disc, which preferably completely covers the respective fluid outlet 58, 60. As a preferred option, there can preferably be a flow through each fluid outlet 58, 60 only in the flow direction from the interior of the respective auxiliary piston 26, 28 outwards into the respective working space 22, 24, and each fluid outlet is preferably designed as a non-return valve.

By way of example, the flow channel 50 has at least or precisely two flow passages 66, 68. For example, each auxiliary piston 26, 28 is connected fluidically to the flow channel 50 via at least one or precisely one flow passage 66, 68 in each case. By way of example, the fluid inlet 52, 54 of each auxiliary valve device 46, 48 of an auxiliary piston 26, 28 is connected fluidically, in each case via a flow passage 66, 68, to the flow channel 50 and a fluid outlet 58, 60 of the respective other auxiliary piston 26, 28. For example, the fluid inlet 52 of the first auxiliary valve device 46 of the first auxiliary piston 26 is connected fluidically to the fluid outlet 58 of the second auxiliary piston 28 via the flow channel 50. In particular, the fluid inlet 54 of the second auxiliary valve device 48 of the second auxiliary piston 28 is connected to the fluid outlet 60 of the first auxiliary piston 26 via the flow channel 50.

In FIG. 2, the fluid flow is illustrated by the dashed arrow for a movement of the piston rod 20 in the direction of compression D. During the operation of the vibration damper 10 and during a movement of the working piston 18 in the direction of compression D, the hydraulic fluid flows through the main piston 14 in the direction of tension Z and opens the first spring disc valve 36, provided that the hydraulic pressure exceeds the opening pressure of the first spring disc valve 36. In parallel with the flow into the main piston 14, the hydraulic fluid flows into the second auxiliary valve device 48 through the fluid inlet 54 of the latter and then opens the second auxiliary valve device 48, provided that the opening pressure of the auxiliary spring disc stack 70 is exceeded. Via the flow passage 68, the hydraulic fluid then flows into the flow channel 50 of the piston rod 20 and out of the latter, via the flow passage 66 into the first auxiliary piston 26, to the fluid outlet 60 of the first auxiliary piston 26 and, if the opening pressure of the outlet spring disc 64 is exceeded, it leaves the first auxiliary piston 26 and enters the working space 22 on the piston-rod side. During a movement of the piston rod 20 in the direction of tension Z, the first auxiliary valve device 46 and the main valve device 16 are opened in corresponding fashion.

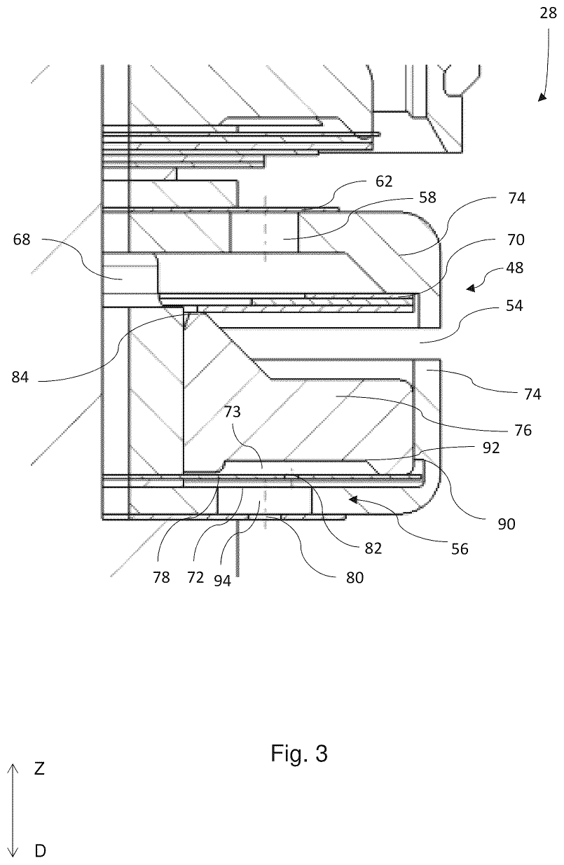

FIG. 3 shows a detail of a segment of the second auxiliary valve device 48. The second auxiliary valve device 48 is preferably of substantially identical design to the first auxiliary valve device 46, and therefore just one of the two auxiliary valve devices 46, 48 is described below by way of example. By way of example, the auxiliary valve device 46, 48 has an auxiliary valve disc stack 70, which in each case has at least one or a plurality of spring discs. The auxiliary valve disc stack 70 is preferably arranged downstream of the fluid inlet 58, 60 of the auxiliary valve device 46, 48 in the direction of flow of the hydraulic fluid. In particular, the auxiliary valve disc stack 70 can be subjected to a preloading force. In the closed position, the auxiliary valve disc stack 70 preferably rests against an auxiliary valve seat 84 and, in particular, is preloaded against the latter with a preloading force. In the opened position of the auxiliary valve device 46, 48, the auxiliary valve disc stack 70 is raised from the auxiliary valve seat 84.

The auxiliary valve device 46, 48 has an auxiliary valve body 74, which is preferably mounted in a fixed position on the piston rod 20. By way of example, the auxiliary valve body 74 forms the housing of the auxiliary valve device 46, 48, in particular of the auxiliary piston 26, 28. In particular, the auxiliary valve body 74 is in the form of a hollow cylinder with a top region facing in the direction of the main piston 14, a side region in the form of a hollow cylinder and a bottom region facing away from the main piston 14. By way of example, an axially movable auxiliary valve piston 76 is arranged within the auxiliary valve body 74. The auxiliary valve piston 76 preferably rests at least partially against the auxiliary valve body 74 and is mounted in such a way as to be movable in the axial direction relative to the latter and to the piston rod 20.

The auxiliary valve piston 76 preferably comprises the auxiliary valve seat 84 and rests by means of the latter against the auxiliary valve disc stack 70. By way of example, the auxiliary valve piston 76 has a diameter that decreases in the direction of the auxiliary valve seat. A movement of the auxiliary valve piston 76 in the axial direction causes a change in the preloading of the auxiliary valve disc stack 70 against the valve seat. By way of example, the auxiliary valve disc stack 70 is secured on, in particular clamped to, the auxiliary valve body 74. By way of example, the auxiliary valve disc stack 70 comprises three spring discs, which rest against one another, wherein the lower spring disc, that resting against the valve seat, has the largest diameter, and, by way of example, the other spring discs have a smaller diameter.

The auxiliary valve device 46, 48 preferably comprises a preloading system 56 for subjecting the auxiliary valve disc stack 70 to a preloading force, in particular for subjecting the auxiliary valve piston 76 to an axial force. The preloading system 56 is preferably part of the auxiliary piston 26, 28 and of the auxiliary valve device 46, 48. The preloading system 56 preferably comprises a first pressure chamber 72 and a second pressure chamber 73, which are connected hydraulically in series with one another. The pressure chambers 72, 73 are arranged in such a way that they interact with the auxiliary valve piston 76, with the result that the auxiliary valve piston 76 is moved axially when there is a change in the pressure in the pressure chambers 72, 73.

The pressure chambers 72, 73 are preferably arranged on the opposite side of the auxiliary valve piston 76 from the auxiliary spring disc stack 70. By way of example, the preloading system 56 furthermore comprises two orifices 80, 82, which each serve as an inlet for allowing hydraulic fluid into a respective pressure chamber 72, 73. The first orifice 80 is preferably designed and arranged as an inlet for allowing hydraulic fluid into the first pressure chamber 72. By way of example, the preloading system 56 has a fluid inlet 94, which is designed as a hole in the auxiliary valve body 74 and, in particular, is arranged on the side of the auxiliary valve body 74 which faces away from the main piston 14. The fluid inlet 74 is preferably covered by a spring disc 96, which forms a non-return valve and, in particular, only allows a hydraulic flow from the auxiliary piston 26, 28, in particular the preloading system 56, into the respective working space 22, 24. By way of example, the first orifice 80 is designed as an opening in the spring disc.

By way of example, the first and the second pressure chamber 72, 73 are separated from one another by a separating spring disc 78, and therefore the first pressure chamber 72 and the second pressure chamber 73 each rest against the spring disc 78. The second orifice 82 is preferably designed as an opening in the spring disc 78 and is an inlet for hydraulic fluid from the first pressure chamber 72 into the second pressure chamber 73. By way of example, the separating spring disc 78 rests against the auxiliary valve piston 76. In particular, the separating spring disc 78 is mounted in such a way as to be axially movable relative to the piston rod 20 and the auxiliary valve body 74. The separating spring disc 78 is preferably movable together with the auxiliary valve piston 76. The first orifice 80 preferably has a larger cross-sectional area than the second orifice 82. By way of example, the first pressure chamber 72 is formed between the separating spring disc 78 and the auxiliary valve body 74, wherein the second pressure chamber 73 is preferably formed between the separating spring disc 78 and the auxiliary valve piston 76.

By way of example, the preloading system 56 furthermore has an axial stop 90 for limiting the axial movement of the separating spring disc 78. By way of example, the axial stop 90 is formed in the auxiliary valve body 74. In particular, the stop 90 is designed as a radial contact surface for contact with, in particular reception of, the separating spring disc 78. The stop 90 preferably limits the volume, in particular the volume enlargement, of the first pressure chamber 72.

The first and the second pressure chamber 72, 73 of the preloading system 56 of a respective auxiliary piston 26, 28 are preferably fluidically connected exclusively to the working space 22, 24 in which the respective auxiliary piston 26, 28 is arranged. The pressure chambers 72, 73 are not connected fluidically to both working spaces 22, 24. By way of example, the auxiliary valve piston 76 has a recess 92, which at least partially forms the second pressure chamber 73. The separating spring disc 78 and the auxiliary valve disc stack 70 are preferably arranged on mutually opposite sides of the auxiliary valve piston 76.

During the operation of the vibration damper 10 and in the case of an excitation of the piston rod 20 in the direction of compression D at a low speed, for example, the first pressure chamber 72 is first filled with hydraulic fluid, which enters the first pressure chamber 72 through the first orifice 80. From the first pressure chamber 72, the hydraulic fluid flows via the second orifice 82 into the second pressure chamber 73, which is likewise filled with hydraulic fluid. The second orifice 82 has a smaller cross section than the first orifice 80, and therefore the second pressure chamber 73 is filled more slowly with hydraulic fluid than the first pressure chamber 72. The rising hydraulic pressure in the first pressure chamber 72 causes a movement of the separating spring disc 78 and of the auxiliary valve piston 76 resting against the latter in the axial direction, with the volume of the first pressure chamber 72 increasing. During a volume enlargement of the first pressure chamber 72, the separating spring disc 78 is moved as far as the stop 90, with the separating spring disc 78 and the auxiliary valve piston 76 being moved at a first speed during this process. Once the stop 90 has been reached and the separating spring disc 78 is resting against the latter, no further volume enlargement of the first pressure chamber 72 is possible. The rise in pressure in the second pressure chamber 73 takes place more slowly owing to the smaller orifice size of the second orifice 82 and thus ensures a slower volume enlargement of the second pressure chamber 73, which results in an axial movement of the auxiliary piston 76. In particular, once the separating spring disc 78 is resting against the stop 90, the auxiliary piston 76 is moved at a second speed, which is lower than the first speed. This ensures that, particularly at slower piston speeds, frequency-sensitive setting of the preloading of the auxiliary valve disc stack 70 takes place. High frequencies cause a movement of the auxiliary valve piston 76 at the first speed, while lower frequencies cause a movement of the auxiliary valve piston 76 initially at the first speed and then at the second speed, and therefore higher damping, in particular preloading of the auxiliary valve disc stack 70, occurs at lower frequencies.

During the operation of the vibration damper and in the case of an excitation in the direction of compression D, hydraulic fluid additionally flows through the fluid inlet 52, 54 to the auxiliary valve device 46, 48 and opens the latter, provided that the hydraulic pressure exceeds the opening pressure of the preferably preloaded auxiliary valve disc stack 70. The hydraulic fluid preferably flows through the auxiliary valve device 46, 48 into the flow channel 50 to the fluid outlet 58, 60 of the opposite auxiliary piston 26, 28 and into the opposite working space 22, 24, in particular the low-pressure space.

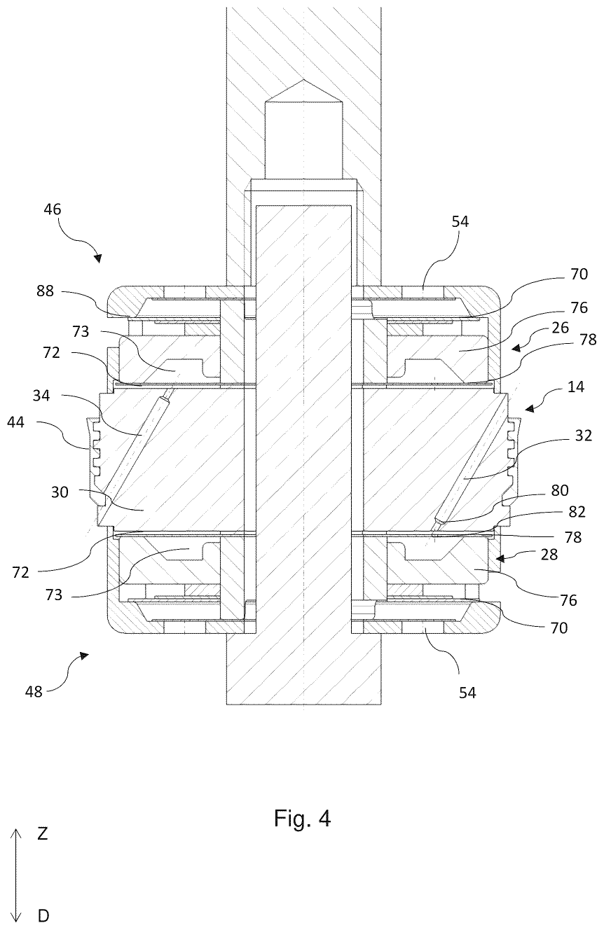

FIG. 4 shows another exemplary embodiment, which corresponds substantially to that in FIGS. 1 to 3, although, in contrast to FIGS. 1 to 3, the main piston 14 does not have a main valve device 16. The main piston 14 has only the main flow channels 32, 34. The damping of the hydraulic flow is preferably performed exclusively by the auxiliary valve devices 46, 48, which are connected to one another via the flow channel 50.

In the exemplary embodiment in FIG. 4, the auxiliary valve piston 76 is, by way of example, of two-part design, wherein that region of the auxiliary valve piston 76 which rests against the auxiliary valve disc stack 70 is, by way of example, designed as an annular disc. It is likewise conceivable that the auxiliary valve piston comprises more than two parts, which are mounted in such a way as to be movable together relative to the auxiliary valve housing 74. By way of example, the auxiliary valve seat 88 is formed in the auxiliary valve housing 74, with the result that, in the closed position, the auxiliary valve disc stack 70 rests against the valve seat 88 of the auxiliary valve housing 74. By way of example, the auxiliary valve disc stack 70 is mounted in such a way as to be axially movable, with the result that it preferably moves together with the auxiliary valve piston.

By way of example, the pressure chambers 72, 73 are arranged on the side of the respective auxiliary piston 26, 28 which faces the main piston 14. By way of example, the fluid inlet 54 for allowing hydraulic fluid into the auxiliary valve device 46, 48 is arranged on the side of the auxiliary piston 26, 28 which faces away from the main piston 14, and, in particular, it is covered by a spring disc, which is designed as a non-return valve. The non-return valve is arranged in such a way that a hydraulic flow from the auxiliary piston 26, 28, in particular the auxiliary valve device 46, 48, into the respective working space 22 is prevented.

By way of example, the main flow channels 32, 34 form the first orifice 80, which is designed as an inlet for allowing hydraulic fluid into the first pressure chamber 72. The main flow channels 34 preferably have a cross-sectional constriction, which forms the first orifice 80.

During the operation of the vibration damper 10 in FIG. 4, in particular during a movement of the piston rod in the direction of compression D, hydraulic fluid flows through the fluid inlet 54 into the second auxiliary piston 48 and then into the flow channel 50 to the first auxiliary piston 26 into the first auxiliary valve device 26. When the opening pressure of the auxiliary valve disc stack 70 of the first auxiliary valve device 46 is exceeded, this valve device is opened and the hydraulic fluid flows off into the low-pressure space. At the same time, hydraulic fluid flows through the second main flow channel 34 into the first pressure chamber 72 and then into the second pressure chamber 73, wherein the preloading of the auxiliary valve disc stack 70 is set in the manner described with reference to FIG. 3.

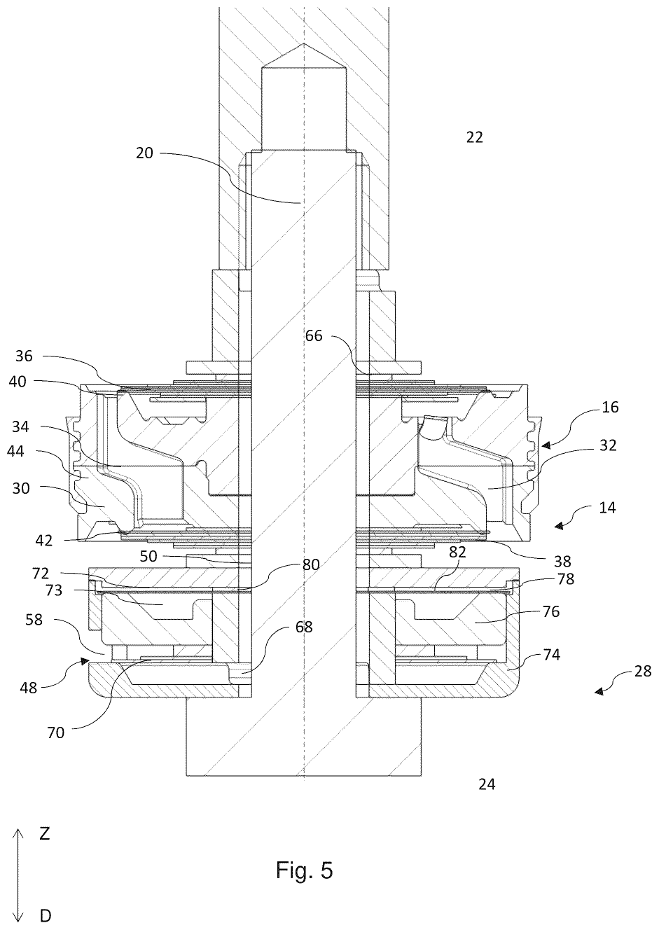

FIG. 5 shows another exemplary embodiment of a vibration damper 10, which corresponds substantially to that in FIGS. 2 and 3. In contrast to the exemplary embodiment in FIGS. 2 and 3, the vibration damper 10 in FIG. 5 has just one auxiliary piston 28. By way of example, this is arranged in the working space 28 remote from the piston rod. It is likewise conceivable for just one auxiliary piston 26 to be arranged in the working space 22 on the piston-rod side. The auxiliary piston 28 corresponds substantially to that in FIG. 4, with the difference that the first orifice 80 is designed as a flow opening in the flow channel 50. Moreover, the auxiliary piston 28 of the exemplary embodiment in FIG. 5 does not have a fluid inlet 54 for allowing fluid from the working space 24 remote from the piston rod into the auxiliary piston 28. In the vibration damper 10 in FIG. 5, the flow passage 68 in the flow channel 50 is designed as a fluid inlet for allowing hydraulic fluid into the auxiliary piston 28. The auxiliary piston 28 is preferably designed in such a way that only hydraulic fluid from the working space 22 in which the auxiliary piston is not arranged flows into the auxiliary piston. By way of example, the auxiliary valve disc stack 70 is designed as a non-return valve and is arranged in such a way that flow through the fluid outlet 58 is possible only in one direction, with the result that the hydraulic fluid flows out of the auxiliary piston 28 exclusively via the fluid outlet 58. In the case of a movement of the piston rod in the direction of tension Z, the hydraulic fluid in the exemplary embodiment in FIG. 5 flows through the flow passage 66 in the piston rod 20 into the flow channel 50 and then through the flow passage 68 into the auxiliary piston 28. In the auxiliary piston 28, the hydraulic fluid flows through the auxiliary piston valve device 48 and opens the auxiliary valve disc stack 70. At the same time, the hydraulic fluid flows through the first orifice 80 into the first pressure chamber 72 and then through the second orifice 82 into the second pressure chamber 73, wherein the auxiliary valve piston 76 is moved in the direction of the auxiliary valve disc stack 70 and preloads the latter.

### LIST OF REFERENCE SIGNS

10 vibration damper
12 damper tube
14 main piston
16 main valve device
18 working piston
piston rod
22 working space on the piston-rod side
24 working space on the side remote from the piston rod
26 first auxiliary piston
28 second auxiliary piston
30 main valve body
32 first main flow channel
34 second main flow channel
36 first spring disc valve
38 second spring disc valve
40 first main valve seat
42 second main valve seat
44 sealing element
46 first auxiliary valve device
48 second auxiliary valve device
50 flow channel
52, 54 fluid inlet
56 preloading system
58, 60 fluid outlet
62, 64 outlet spring discs
66, 68 flow passage
70 auxiliary valve disc stack
72 first pressure chamber
73 second pressure chamber
74 auxiliary valve body
76 auxiliary valve piston
78 separating spring disc
80 first orifice
82 second orifice
84 auxiliary valve seat
86 spacing washer
88 valve seat
90 stop
92 recess
94 fluid inlet
96 spring disc

1. A vibration damper for a motor vehicle, comprising:
a damper tube, and
a working piston, which is arranged in such a way as to be axially movable within the damper tube and divides an interior of the damper tube into a working space on the piston-rod side and a working space on the side remote from the piston rod,
wherein the working piston has a main piston and at least one auxiliary piston,
wherein the auxiliary piston has an auxiliary valve device, which is connected fluidically to a working space of the damper tube via a flow channel,
wherein the auxiliary valve device comprises:
an auxiliary valve body and an auxiliary valve piston, which is movable axially relative to the latter, and
an auxiliary valve disc stack, which interacts with the auxiliary valve piston,
wherein the auxiliary valve device has a preloading system for subjecting the auxiliary valve disc stack to a preloading force, and wherein the preloading system comprises a first pressure chamber and a second pressure chamber, which each have a variable volume.

2. The vibration damper according to claim 1, wherein the first and second pressure chambers are connected hydraulically in series with one another.

3. The vibration damper according to claim 1, wherein the preloading system has a first orifice for allowing hydraulic fluid into the first pressure chamber and a second orifice for allowing hydraulic fluid into the second pressure chamber.

4. The vibration damper according to claim 3, wherein the first orifice has a larger cross-sectional area than the second orifice.

5. The vibration damper according to claim 1, wherein the preloading system has a separating disc, which separates the first pressure chamber and the second pressure chamber from one another.

6. The vibration damper according to claim 5, wherein the second orifice is designed as an opening in the separating disc for fluidically connecting the first and the second pressure chamber.

7. The vibration damper according to claim 5, wherein the separating disc is mounted in such a way as to be axially movable relative to the auxiliary valve body.

8. The vibration damper according to claim 7, wherein the preloading system has an axial stop for limiting the axial movement of the separating disc.

9. The vibration damper according to claim 5, wherein the separating disc rests against the auxiliary valve piston.

10. The vibration damper according to claim 1, wherein the flow channel has a flow passage, which opens into the first auxiliary piston to allow the entry of hydraulic fluid, and wherein the flow channel has a further flow passage, which opens into the second auxiliary piston to allow the entry of hydraulic fluid.

11. The vibration damper according to claim 1, wherein the auxiliary valve disc stack is secured on the valve body.

12. The vibration damper according to claim 1, wherein the auxiliary valve piston has a recess, which at least partially forms the second pressure chamber.

13. The vibration damper according to claim 1, wherein the main piston has a main valve device, and the flow channel is arranged hydraulically in parallel with the main valve device.

14. The vibration damper according to claim 1, wherein the working piston has two auxiliary pistons, each having an auxiliary valve device, and wherein the auxiliary valve devices are connected fluidically to one another via the flow channel.

15. The vibration damper according to claim 14, wherein each auxiliary valve device has a fluid inlet for allowing hydraulic fluid to enter the auxiliary valve device, wherein each auxiliary piston has a fluid outlet for allowing hydraulic fluid out of the auxiliary piston, and wherein the fluid inlet of the first auxiliary valve device is connected fluidically to the fluid outlet of the second auxiliary piston via the flow channel.
